(19) United States
(12) Patent Application Publication
(10) Pub. No.: US 2026/0328153 A1
(43) Pub. Date: Oct. 22, 2026

(54) METHOD FOR OPERATING AN INTERNAL COMBUSTION ENGINE CLOSE TO A COMBUSTION LIMIT IN THE LOW POWER RANGE

(71) Applicant: Robert Bosch GmbH, Stuttgart (DE)

(72) Inventors: Johannes Zeller, Stuttgart (DE); Holger Kauss, Wernau (DE); Yvan Gauthier, Lichtenstein (DE)

(21) Appl. No.: 19/114,985

(22) PCT Filed: Sep. 25, 2023
(86) PCT No.: PCT/EP2023/076356

§ 371 Date: Mar. 25, 2025

(30) Foreign Application Priority Data
Sep. 26, 2022 (DE) 10 2022 210 136.7

(51) Int. Cl. F02D 41/14; F02D 41/00; F02D 41/38; F02D 43/00; F02P 5/15

(52) U.S. Cl. CPC F02D 41/1454; F02D 41/008; F02D 41/38; F02D 43/00; F02P 5/151; F02D 2200/0602; F02D 2200/101

(57) ABSTRACT

A method is proposed for operating an internal combustion engine, in particular a hydrogen engine, having a plurality of cylinders, by determining a combustion air ratio of the internal combustion engine, comparing the determined combustion air ratio to a predetermined lower limit value and an upper limit value, which corresponds to the combustion limit, in order to regulate the operation of the internal combustion engine by: a) adjusting (10) cylinder-specific injection quantities of fuel based on a rail pressure signal of the internal combustion engine, as soon as the determined combustion air ratio corresponds to at most the lower limit value, in order to achieve an equalization of the injection quantities of the cylinders, b) adjusting (12) the cylinder-specific injection quantities of fuel based on the speed of the internal combustion engine, as soon as the determined combustion air ratio in a transition range close to the combustion limit is above the lower limit value and below the upper limit value, in order to account for cycle fluctuations of the cylinders, c) switching off (14) at least one cylinder and adjusting the cylinder-specific injection quantities of fuel distributed to the remaining cylinders according to measure a) or measure b), as soon as the determined combustion air ratio has reached the upper limit value and thus the combustion limit, wherein, during all measures a), b), or c), the respective ignition angle is kept in an efficiency-optimized range.

### BACKGROUND

The present invention relates to a method of operating an internal combustion engine, in particular a hydrogen engine, having a plurality of cylinders, and to a controller for controlling an internal combustion engine, in particular a hydrogen engine, having a plurality of cylinders.

The operation of hydrogen internal combustion engines having a plurality of cylinders in the low-load range, in particular while idling, is challenging. A combustion air ratio λ significantly greater than 1 is aimed for, in order to avoid nitrogen oxide emissions and to improve fuel consumption and responsiveness of the engine. However, an excessive increase in the combustion air ratio can lead to potential combustion stability problems. It is known to address this problem through throttled operation, cylinder deactivation, or corresponding control of a thrust air valve, wherein these measures are however not clearly distinguishable from one another. Moreover, the combustion limit, i.e. the range where combustion instability can occur due to an excessively high combustion air ratio, cannot be cleanly detected during engine operation, and therefore, measures to avoid this range can usually only be initiated based on boundary conditions determined during engine application.

### SUMMARY

An internal combustion engine operating on such a lean homogeneous combustion method offers, unlike a stoichiometric combustion method, the advantage of being able to perform rapid torque adjustments by modifying the fuel quantity without having to account for the inertia of an air system. As a result, torque-effective interventions via ignition regulation, which are associated with efficiency disadvantages, can be reduced to a minimum. However, when controlling torque through fuel quantity, it must be ensured that the so-called combustion limits of the fuel-air mixture are maintained, i.e. that an excessively high combustion air ratio λ is avoided. When this combustion limit is reached, the fuel quantity cannot be reduced further without generating combustion instabilities. Consequently, the torque must be controlled with further measures, some of which degrade efficiency.

Thus, the problem addressed by the invention is to propose a method or system for improved idle control while largely avoiding ignition angle adjustments and maximizing the use of combustion limits.

The problem is solved by a method having the features of the disclosure. Advantageous embodiments and further developments can be gathered from the dependent claims and the subsequent description.

A method is proposed for operating an internal combustion engine, in particular a hydrogen engine, having a plurality of cylinders. The method comprises determining a combustion air ratio of the internal combustion engine, comparing the determined combustion air ratio to a predetermined lower limit value and an upper limit value, which corresponds to the combustion limit, as well as regulating the operation of the internal combustion engine by torque-effective measures according to the following regulation cascade:
adjusting cylinder-specific injection quantities of fuel based on a rail pressure signal of the internal combustion engine, as soon as the determined combustion air ratio corresponds to at most the lower limit value, in order to achieve an equalization of the injection quantities of the cylinders,
adjusting the cylinder-specific injection quantities of fuel based on the speed of the internal combustion engine, as soon as the determined combustion air ratio in a transition range close to the combustion limit is above the lower limit value and below the upper limit value, in order to account for cycle fluctuations of the cylinders,
switching off at least one cylinder and adjusting the cylinder-specific injection quantities of fuel distributed to the remaining cylinders according to measure a) or measure b), as soon as the determined combustion air ratio has reached the upper limit value and thus the combustion limit,
wherein, during all measures a), b), or c), the respective ignition angle is kept in an efficiency-optimized range.

The operation of the internal combustion engine by a method according to the invention in a low-load range is characterized by prioritizing torque-effective interventions within the framework of the specified regulation cascade in order to largely avoid efficiency-decreasing measures. The execution of the individual possible interventions depends on a determined combustion air ratio of the engine, which is denoted as λ and indicates the mass ratio of air to fuel relative to the respective stoichiometric ratio. In this context, it should be noted that a combustion limit is to be considered as the upper limit value of the combustion air ratio, above which combustion instabilities could occur due to an air content that is too high. A lower limit value with a sufficient safety margin from the combustion limit is specified, wherein a meaningful selection of the lower limit value is discussed further below.

If the determined combustion air ratio is far enough below the combustion limit and at most at the lower limit value, the method according to the invention regulates the fuel supply to individual cylinders based on the rail pressure signal, which is characterized above as measure or priority a). The combustion air ratio is thus richer or lower than or equal to the lower limit value. The function implemented in a controller adjusts the amount of fuel supplied to cylinders with a fuel quantity that deviates from the engine cylinder average to the cylinder average level. In particular, when the supplied fuel quantity is too low, a cylinder-specific combustion air ratio is too high, which is consequently also closer to the combustion limit.

In this process, it is possible to evaluate a minimum pressure in the rail during injection to the cylinders. For cylinders in which a higher minimum rail pressure is observed during injection compared to the average of other cylinders, the control duration of the corresponding injector could be increased until the minimum rail pressure is slightly lower or slightly higher than the previously calculated cylinder average.

A combustion air ratio band could be defined around the previously calculated engine cylinder average, within which the combustion air ratio should fall after a corresponding correction of the cylinder's fuel quantity. This band could be characterized by a fuel injection rate that is a certain percentage lower or higher than the engine average, which could be about 10%. The ignition angles are maintained within an efficiency-optimized range.

However, if the combustion air ratio is close to the combustion limit, i.e. the upper limit value, but still below it, the invention provides for a regulation of the fuel supply based on the speed signal within this transition range close to the combustion limit. In this process, the speed signal is evaluated, and high cycle fluctuations of individual cylinders at the combustion limit are equalized, in particular by increasing the injection amount to the level of the remaining engine cylinders. This is labeled as b) above. When detecting the speed via a speed sensor, an engine's rotational irregularity can be determined, which allows inferences to be drawn about the cycle fluctuation of each individual cylinder. If a cylinder shows increased cycle fluctuation, the fuel supply to that cylinder is increased in order to increase the distance from the combustion limit for that cylinder. Because, in addition to the proximity to the combustion limit, a possible difference in the amount of fuel introduced per cylinder can also be relevant as a cause of cycle fluctuations, a comparison of the differences between cylinders in a rail pressure signal (as a measure of actual introduced fuel quantities) and the rotational speed irregularity (as a measure of the deviations due to both possible causes) can be used in order to distinguish between the two possible causes. Thus, all cylinders are brought as close as possible to the combustion limit, taking into account all influences on the combustion limit, such as the quantity fluctuation of the individual fuel dosing valves and any unequal distribution of the cylinder filling.

Only when the combustion limit is reached will a selective cylinder deactivation be performed in order to achieve a cylinder-specific greater distance from the combustion limit while also distributing the amount of fuel required in order to achieve the desired torque to the remaining, active cylinders. As long as the combustion air ratio is not at the combustion limit in this operating mode, regulation should continue to be done purely through the adjustment of fuel supply, wherein a distinction between a) and b) is made here depending on the resulting combustion air ratio.

In one advantageous embodiment, the method further comprises: d) decreasing the engine speed, if after step c) the combustion air ratio of individual cylinders reaches at least 95% of the upper limit value. To maintain torque, the individual filling of each cylinder can be increased, consequently achieving a greater distance from the combustion limit. The engine's natural speed must be taken into account.

In an advantageous embodiment, the method further comprises: e) adjusting the ignition angle from the efficiency-optimized range, if after step d) the combustion air ratio of individual cylinders reaches at least 95% of the upper limit value. The adjustment of the ignition angle of individual cylinders is only performed when the previous measures mentioned in a) to d) no longer lead to success. The combustion could become less efficient.

Steps a) to e) should be understood as measures to be taken if the internal combustion engine should be too close to or directly at the combustion limit. They are to be evaluated with decreasing priority from a) to e), i.e. the individual measures can be carried out in sequence until operation sufficiently distanced from the combustion limit is possible.

The lower limit value can be determined as the difference between the upper limit value and a subtrahend ϵ, wherein the subtrahend & is formed from an addition of combustion air ratio influences. Symmetrical tolerance contributions are assumed. The combustion air ratio influences can comprise an upper boost pressure tolerance amount of an air system, a lower shot-to-shot scattering of an injector injection mass (about 5%), and an upper cylinder air charge deviation from an engine mean value.

In addition, a plausibility check can be carried out based on an air-fuel ratio range currently calculated in an air system model in order to ensure that the engine is actually operating in the near-combustion limit range (this could be particularly relevant when a cylinder deactivation is active), thus enabling an unambiguous correlation between speed irregularity and proximity to the combustion limit.

The invention further relates to a control unit for controlling an internal combustion engine, in particular a hydrogen engine, having a plurality of cylinders, comprising a rail pressure sensor input, a speed sensor input, a computing unit, and a plurality of control outputs, wherein, for performing the method described above, the computing unit is configured so as determine a combustion air ratio of the internal combustion engine and compare it to a predetermined lower limit value and an upper limit value, and wherein the control unit is configured so as to regulate the operation of the internal combustion engine in a cascaded manner by generating and providing control signals to the control outputs as follows:
adjusting cylinder-specific injection quantities of fuel based on a rail pressure signal, as soon as the determined combustion air ratio corresponds to at most the lower limit value, b) adjusting the cylinder-specific injection quantities of fuel based on the speed, as soon as the determined combustion air ratio lies above the lower limit value and below the upper limit value, c) switching off at least one cylinder and adjust the cylinder-specific injection quantities of fuel distributed to the remaining cylinders according to a) or b), as soon as the determined combustion air ratio reaches the upper limit value, wherein the control unit is configured so as to keep the respective ignition angle in an efficiency-optimized range during the aforementioned measures a), b), and c).

In an advantageous embodiment, the controller is configured so as to d) decrease the speed of the engine, if after performing c) the combustion air ratio of individual cylinders reaches at least 95% of the upper limit value.

In an advantageous embodiment, the controller is configured so as to e) adjust the ignition angle from the efficiency-optimized range, if after performing d) the combustion air ratio of individual cylinders reaches at least 95% of the upper limit value.

In an advantageous embodiment, the control unit is configured so as to determine the lower limit value as a difference between the upper limit value and a subtrahend ϵ, wherein the subtrahend ϵ is formed from an addition of combustion air ratio influences.

In an advantageous embodiment, the control unit is configured so as to perform a simulation of the internal combustion engine, wherein the determining of the combustion air ratio is performed based on the simulation.

Further measures for improving the invention are described in greater detail hereinafter, together with the description of the preferred exemplary embodiments of the invention, with reference to the figures.

### BRIEF DESCRIPTION OF THE DRAWINGS

Shown are:

FIG. 1 a schematic illustration of a method for operating an internal combustion engine;

FIG. 2 a block-based illustration of a regulation strategy;

FIG. 3 an exemplary illustration of two different operating states and corresponding regulation;

FIG. 4 a schematic illustration of system for operating an internal combustion engine.

### DETAILED DESCRIPTION

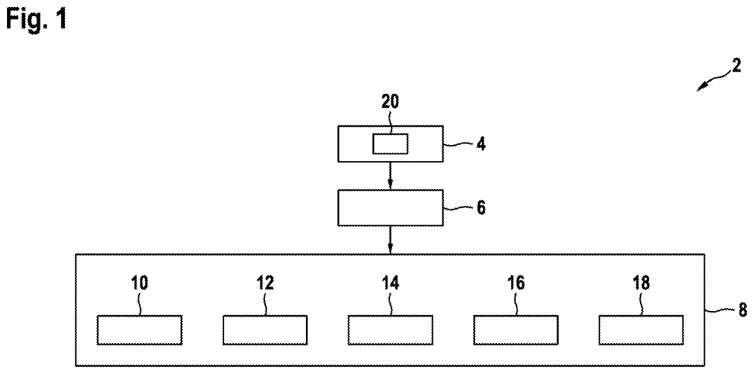

FIG. 1 shows a method 2 for operating an internal combustion engine, in particular a hydrogen engine having a plurality of cylinders. The method 2 begins with the determining of 4 a combustion air ratio, which is then compared 6 to a predetermined lower limit value and an upper limit value. Subsequently, the operation of the internal combustion engine is regulated by a priority-driven strategy 8, wherein the execution depends on the previous comparison with the limit values. In descending order of priority, the regulation comprises:
adjusting 10 cylinder-specific injection quantities of fuel based on a rail pressure signal, as soon as the determined combustion air ratio corresponds to at most the lower limit value,
adjusting 12 the cylinder-specific injection quantities of fuel based on the speed, as soon as the determined combustion air ratio is above the lower limit value and below the upper limit value,
switching off 14 at least one cylinder and adjusting 10 or 12 the cylinder-specific injection quantities of fuel distributed to the remaining cylinders according to a) or b), as soon as the determined combustion air ratio has reached the upper limit value, wherein the respective ignition angle is kept in an efficiency-optimized range,
decreasing 16 the engine speed, if after step c) the combustion air ratio of individual cylinders reaches at least 95% of the upper limit value, or
adjusting 18 the ignition angle from the efficiency-optimized range, if after step d) the combustion air ratio of individual cylinders reaches at least 95% of the upper limit value. The determining 4 of the combustion air ratio can include performing 20 a (simplified) simulation model of an internal combustion engine. The simulation model can, in the simplest case, be implemented as a look-up table in which experimentally or theoretically determined combustion air ratios are stored and retrievable.

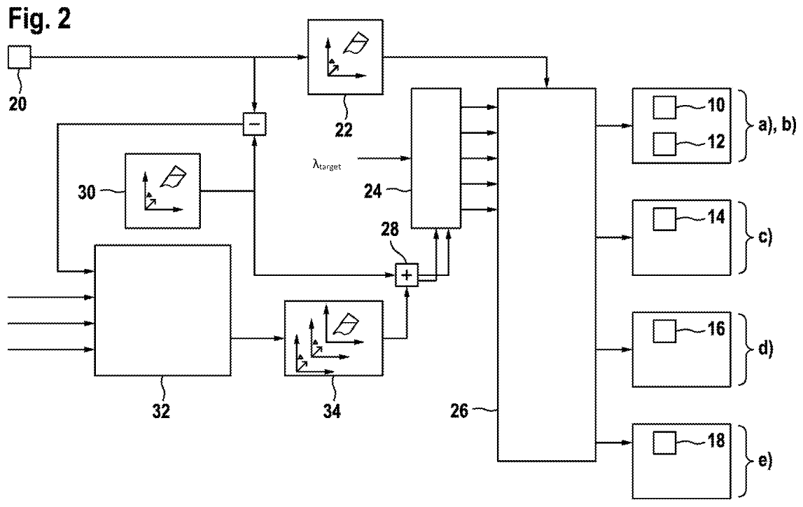

FIG. 2 shows a block-based illustration of a regulation strategy. In block 22, a plausibility check is carried out in order to determine whether a determined combustion air ratio approximately corresponds to a simulated combustion air ratio or lies close to a combustion limit. This can be used as a release condition for the further method.

The comparison 6 is performed in block 24, which is fed with a target value for the combustion air ratio λ_{target} and current, cylinder-specific lower limits for the current air charge of the cylinders. This results in deviations, which are evaluated in a subsequent block 26 and used in order to prioritize active measures for operating the internal combustion engine. These include, as previously explained, adjusting 10 and 12 cylinder-specific injection quantities, switching off 14 at least one cylinder, decreasing 16 the engine speed, and adjusting 18 the ignition angle.

The cylinder-specific lower limit values are formed in block 28 from a base value 30 for a current combustion limit and combustion air ratio influences. The latter are formed by a cylinder-specific analysis 32 of the irregularity of the speed or cylinder pressure signal over several cycles and a comparison to a rail pressure signal and are subjected to an operating point-based and cylinder-specific weighting 34.

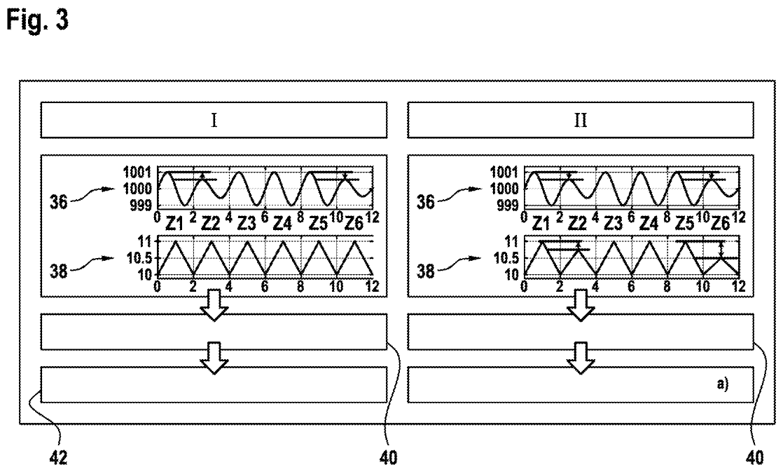

FIG. 3 shows two examples I and II of different operating states of an engine having six cylinders Z1 to Z6, as well as a corresponding regulation. In I, the combustion air ratio exceeds the lower limit and falls below the upper limit, so that the internal combustion engine operates near the combustion limit. Therefore, the speed signal is primarily analyzed and compared to the rail pressure signal. This process is repeated over a plurality of cycles. The analysis is labeled as block 40. An examination of the engine speed reveals a speed irregularity, i.e. a cycle fluctuation in which the cylinders Z2 and Z6 are notable due to a momentary decrease in rotation speed (see diagram 36). The rail pressure (see diagram 38) exhibits the same behavior for all cylinders Z1-Z6, indicating an even filling of the cylinders. As a measure here, there is a (load-based) lowering 42 of the combustion limit for cylinders Z2 and Z6 as an adjustment of the regulation; none of the measures a) to e) are performed.

In Example II, the lower limit value is not reached, so the rail pressure signal is primarily evaluated. The rail pressure signal is notable for both cylinders Z2 and Z6. As a measure, the cylinder-specific injection quantities are increased based on a rail pressure signal-based regulation (measure a))

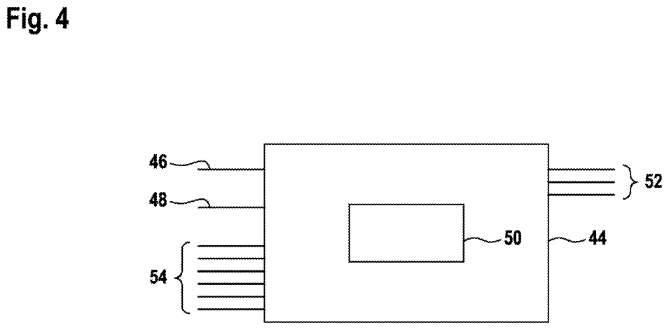

Finally, FIG. 4 shows an exemplary illustration of a controller 44 for controlling an internal combustion engine, in particular a hydrogen engine having a plurality of cylinders. The controller comprises a rail pressure sensor input 46, a speed sensor input 48, a computing unit 50, and a plurality of control outputs 52. Furthermore, the controller 44 comprises a plurality of optional cylinder pressure inputs 54. The computing unit 50 is coupled to the inputs 46, 48, and 54, as well as to the control outputs 52, and is configured so as to determine a combustion air ratio of the internal combustion engine and to compare it to a predetermined lower limit value and an upper limit value. The controller 44 is further configured so as to regulate the operation of the internal combustion engine by generating and providing control signals to the control outputs 52, in order to a) adjust cylinder-specific injection quantities of fuel based on a rail pressure signal at the rail pressure sensor input 46, as soon as the determined combustion air ratio corresponds to at most the lower limit value, or b) adjust the cylinder-specific injection quantities of fuel based on the speed from the speed sensor input 48, as soon as the determined combustion air ratio lies above the lower limit value and below the upper limit value, or c) switch off at least one cylinder and adjust the cylinder-specific injection quantities of fuel distributed to the remaining cylinders according to a) or b), as soon as the determined combustion air ratio reaches the upper limit value. The control unit 44 is configured so as to keep the respective ignition angle in an efficiency-optimized range during a), b), and c). As shown above, measures d) and e) can be performed by the controller 44 according to the determined combustion air ratio.

1. A method (2) of operating an internal combustion engine, in having a plurality of cylinders, the method comprising:
determining (4) a combustion air ratio of the internal combustion engine, comparing (6) the determined combustion air ratio to a predetermined lower limit value and an upper limit value corresponding to the combustion limit, and regulating (8) the operation of the internal combustion engine by torque-effective measures according to the following regulation cascade:
a) adjusting (10) cylinder-specific injection quantities of fuel based on a rail pressure signal of the internal combustion engine, as soon as the determined combustion air ratio corresponds to at most the lower limit value, in order to achieve an equalization of the injection quantities of the cylinders,
b) adjusting (12) the cylinder-specific injection quantities of fuel based on the speed of the internal combustion engine, as soon as the determined combustion air ratio in a transition range close to the combustion limit is above the lower limit value and below the upper limit value, in order to account for cycle fluctuations of the cylinders, and
c) switching off (14) at least one cylinder and adjusting the cylinder-specific injection quantities of fuel distributed to the remaining cylinders according to measure a) or measure b), as soon as the determined combustion air ratio has reached the upper limit value and thus the combustion limit,
wherein, during all measures a), b), or c), the respective ignition angle is kept in an efficiency-optimized range.

2. The method (2) according to claim 1, wherein the method (2) further comprises:
d) decreasing (16) the speed of the engine, if after measure c) the combustion air ratio of individual cylinders reaches at least 95% of the upper limit value.

3. The method (2) according to claim 2, wherein the method (2) further comprises:
e) adjusting (18) the ignition angle from the efficiency-optimized range, if after measure d) the combustion air ratio of individual cylinders reaches at least 95% of the upper limit value.

4. The method (2) according to claim 1, further comprising a determining of the lower limit value as a difference between the upper limit value and a subtrahend ϵ, wherein the subtrahend E is formed from an addition of combustion air ratio influences.

5. The method (2) according to claim 1, wherein the determining (4) of the combustion air ratio is performed using a simulation model.

6. A controller (44) for controlling an internal combustion engine having a plurality of cylinders, comprising:
a rail pressure sensor input (46),
a speed sensor input (48), a computing unit (50), and a plurality of control outputs (52), wherein the computing unit (50) is configured to determine a combustion air ratio of the internal combustion engine and compare it to a predetermined lower limit value and an upper limit value corresponding to the combustion limit, and wherein the controller is configured to carry out torque-effective measures according to the following regulation cascade by generating and providing control signals at the control outputs (52):
a) adjusting (10) cylinder-specific injection quantities of fuel based on a rail pressure signal of the internal combustion engine, as soon as the determined combustion air ratio corresponds to at most the lower limit value, in order to achieve an equalization of the injection quantities of the cylinders,
b) adjusting (12) the cylinder-specific injection quantities of fuel based on the speed of the internal combustion engine, as soon as the determined combustion air ratio in a transition range close to the combustion limit is above the lower limit value and below the upper limit value, in order to account for cycle fluctuations of the cylinders, and
c) switching off (14) at least one cylinder and adjusting the cylinder-specific injection quantities of fuel distributed to the remaining cylinders according to measure a) or measure b), as soon as the determined combustion air ratio has reached the upper limit value and thus the combustion limit, wherein, during all measures a), b), or c), the controller (44) is configured so as to keep the respective ignition angle in an efficiency-optimized range.

7. The controller (44) according to claim 6, wherein the controller (44) is configured so as to: d) decrease (16) the speed of the engine, if after performing c) the combustion air ratio of individual cylinders reaches at least 95% of the upper limit value.

8. The controller (44) according to claim 7,
wherein the controller is configured so as to:
e) adjust (18) the ignition angle from the efficiency-optimized range, if after performing d) the combustion air ratio of individual cylinders reaches at least 95% of the upper limit value.

9. The controller (44) according to claim 6,
wherein the controller (44) is configured so as to determine the lower limit value as a difference between the upper limit value and a subtrahend ϵ, wherein the subtrahend E is formed from an addition of combustion air ratio influences.

10. The controller (44) according to claim 6,
wherein the controller (44) is configured so as to perform a simulation of the internal combustion engine, wherein the determining of the combustion air ratio is performed based on the simulation.
